(19) United States
(12) Patent Application Publication
(10) Pub. No.: US 2022/0370965 A1
(43) Pub. Date: Nov. 24, 2022

(54) METHOD, SYSTEM, APPARATUS AND FORMULATIONS FOR PRODUCING OIL-BASED BLENDS AND MICROEMULSIONS AND NANOEMULSIONS

(71) Applicant: Joao Carlos Fernandes Serodio, Swansea (GB)

(72) Inventor: Joao Carlos Fernandes Serodio, Swansea (GB)

(21) Appl. No.: 17/774,758

(22) PCT Filed: Nov. 5, 2020
(86) PCT No.: PCT/GB2020/052807

§ 371 Date: May 5, 2022

Related U.S. Application Data
(60) Provisional application No. 62/931,084, filed on Nov. 5, 2019.

(51) Int. Cl. B01F 23/41; B01F 23/40; B01F 25/314; B01F 25/32; B01F 25/452; C10L 1/32; C10L 1/224; C10L 10/02

(52) U.S. Cl. CPC B01F 23/4105; B01F 23/49; B01F 25/3141; B01F 25/31425; B01F 25/32; B01F 25/45211; C10L 1/328; C10L 1/224; C10L 10/02; C10L 2250/084; C10L 2250/086; C10L 2290/146; C10L 2290/24

(57) ABSTRACT

A process for producing a microemulsion or nanoemulsion comprising water and at least one hydrocarbon or oil, comprising the steps of: a) providing the hydrocarbon or oil, water, one or more additives, a solvent, and a hydrophilic surfactant formulation comprising an amine or amide derivative non-ionic surfactant which is a fatty acid alkanolamide, one or more ethoxylated alcohols and/or ethoxylated alkylphenols, and a non-ionic fatty acid ester; b) by a mixing or stirring device operating at a mixing or stirring speed in the range 100 rpm and 15000 rpm, mixing or stirring the hydrophilic surfactant formulation and additive into the solvent, to produce a hydrophilic self-emulsifying blend; c) adding water to the hydrophilic self-emulsifying blend and the hydrocarbon or oil to produce a water-in-hydrocarbon/oil microemulsion or nanoemulsion, wherein the microemulsion or nanoemulsion comprises: 46% or more by mass of the hydrocarbon or oil, 4% to 36% by mass of water, a mass ratio of hydrophilic surfactant formulation to water in the range 1:10 to 1:2, 0.1% to 5% by mass of additive, 1.2% or more by mass of the solvent, a dispersed particle size in the range 1 nm to 500 nm, and a polydispersity index of 35% PdI or less, wherein the percentages by mass of the hydrocarbon or oil, water, formulation, additive and solvent together add up to 100%.

### CROSS-REFERENCE TO RELATED APPLICATIONS

This application is a Section 371 of International Application No. PCT/GB2020/052807, filed Nov. 5, 2020, which published in the English language on May 14, 2020, under International Publication No. WO 2021/090010 A1, which claims priority to U.S. Provisional Application No. 62/931,084, filed Nov. 5, 2019. Each disclosure is incorporated herein by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### BACKGROUND OF THE INVENTION

### Field of the Invention

The present invention relates to a process for producing a microemulsion or nanoemulsion comprising water and at least one hydrocarbon or oil, an apparatus for providing a microemulsion or nanoemulsion in a hydrocarbon flow or oil flow, a surfactant formulation for mixing with water and a solvent to form a microemulsion or nanoemulsion of water-in-solvent, and a system for the same.

### Description of Related Art

Global warming is a global problem, and burning carbon-based fuel provides a significant contribution to greenhouse gases. The market is faced with the demand for novel, alternative solutions to significantly reduce the use of carbon-based fuel and provide a reduction of the emissions produced from the consumption those fuels.

Water in fuel emulsion technology (WFE) has been used in the transport sector with the aim of making vehicles more environmentally-friendly. More specifically, WFE has been used in road diesel consumers of the road transport sector, and distillate and residual fuel consumers of the marine sector, accounting for just over one third (33.9%) of the world total oil consumption and 90.1% of primary target market. NOₓ and CO₂ emissions from a diesel vehicle are produced in significant quantities when diesel undergoes combustion during a normal use scenario.

Water in fuel emulsions (WFE) are generally formed by at least: a hydrocarbon, biodiesel, alcohol-based fuel and/or fuel blends, as the continuous phase; tap water normally treat by deionization, as the dispersed phase; and one or more surfactants, generally non-ionic, as the emulsifier and/or agent.

In water in fuel nanoemulsions (WFE), the continuous phase is a hydrocarbon, biodiesel, alcohol-based fuels and/or fuel blends. A “fuel blend” typically consists of a hydrocarbon petroleum fuel as the continuous phase and a renewable diesel, biofuel and/or alcohol as the dispersed phase, depending on the application (e.g. road diesel EN590).

Alternative technologies are available in the market to reduce emissions but have their own limitations and cost. For example, there are alternative and cleaner fuels (electric, natural gas, propane, renewable diesel, biodiesel, ethanol, etc); fuel and lubricant technology (lubricant oil, Alternative fuels and fuel additives); in cylinder control systems (fuel injection systems, intake boosting, air-handling technologies, exhaust gas recirculation— EGR, combustion chamber design and water in fuel emulsion); aftertreatment systems (diesel oxidation catalyst—DOC, selective catalyst reduction—SCR, diesel particle filters—DPF, exhaust gas cleaning system—EGCS and system integration, NOₓ storage catalyst—NSC); and control, diagnostics & powertrain technologies (hybridization, diagnosis, controls, gearbox design and powertrain matching).

WFE technology is recognized as an economical solution for incorporation into a diesel engine to improve combustion without requiring engine modification. This can reduce NOₓ formation, as well as reduce the rate of formation of soot particles and enhance their burnout characteristics by increasing the concentration of oxidation species. The use of nanoparticle size water in fuel emulsions to enhance the combustion and emission characteristics has been investigated (SureshVellaiyana, 2016) but there are inconsistent reports in terms of (specific fuel consumption (SFC), carbon monoxide (CO) and hydrocarbon (HC) emissions. In addition, engine operating variables and ambient conditions also affect atomization and general combustion process and restrict drawing a general conclusion of the source of the WFE efficiency. The reviews also highlight that the comparative advantage of water in fuel emulsions to diesel fuel are not precisely known and understood, due to insufficient knowledge on micro-explosion phenomenon and the associated combustion phenomenon, resulting from confinement of the research to engine tests on water in diesel emulsions only, which are inconsistent, with not much focus on the influence of water concentration, surfactant concentration, or HLB value of surfactant on the emulsion stability (Kiran Raj Bukkarapu, 2017).

Adding water to fuel backdates to the early 1900s. In the early 2000s, a commercial attempt took place by major global players using macro sized (low quality) diesel emulsified fuels, known at the time as ‘white diesel’. However, the low-quality emulsified fuels result in low combustion efficiency, leading to an increase of the specific fuel consumption rates, and in extreme cases, mechanical failure and liabilities.

In general terms, emulsified fuels are produced using prior art materials, equipment, and methods, with water contents varying between 10 to 50% (in mass). Such emulsified fuels are normally offered as a ready-to-use or short-term storage fuel for use as a single fuel or bi-fuel (hybrid), or alternatively there is a production plant for the end-user to produce their own WFE using chemical formulation supplied by licensed companies. An independent Global Emulsified Fuel Market Report, focused in marine and industrial applications was offered by Cognitive Market Research (Cognitive, 2020)

Considering emulsions in general, an emulsion is a dispersion made up of two immiscible liquid phases which are mixed using mechanical shear and surfactant. Particle size of a conventional emulsion grows continuously with time and hence finally separation occurs at gravitational force thus these emulsions are thermodynamically unstable. There are several theories regarding emulsification, including the surface tension theory, the repulsion theory, the viscosity modification theory, the oriented-wedge theory, and the plastic- or interfacial-film theory (Santosh Nemichand Kale, 2017).

There is huge amount of literature on the basic and advanced principles of emulsions, e.g., “Introduction to macro and microemulsions” (SHAH, 1985), “Microemulsion and microemulsion behavior of systems containing oil, water and non-ionic surfactant” (Horsup, 1991), “Emulsion micro emulsion and nano emulsion: a review” (Kale S., 2017), “Microemulsions” (Eastoe J., et al) and “Surfactant science—principles & practice” (Abbott S., 2018).

In general emulsions can be classified based on their morphology, i.e. a ‘water-based’, or oil-in-water (O/W), emulsion has water as the continuous phase and oil as the dispersed phase, whereas the inversed condition yields an ‘oil-based’ or water-in-oil (W/O) emulsion. Multiple emulsions can be subdivided as single emulsions in two categories, oil in water in oil (o/w/o) and water in oil in water (w/o/w). They can be characterized accordingly to their properties and behavior as macroemulsions (biphasic), nanoemulsions (monophasic) or microemulsions (monophasic). This is mainly defined by particle size (PS), polydispersity (Pd or index PdI) and the dispersion phase kinetic and thermodynamic stability.

Microemulsions were first introduced by Schulman et. al in 1943. A microemulsion is defined as a clear, thermodynamically stable dispersion of two immiscible liquids containing appropriate amounts of surfactants, or surfactants and co-surfactants. The dispersed phase consists of small droplets with diameter in the range of 5 to 100 nm. The small droplet size in microemulsions also leads to a large surface-to-volume ratio in an oil-water system. This is important for chemical reactions in which the rate of reaction depends on the interfacial area (SHAH, 1985).

The active ingredients in the form of nanoparticles have a high surface-to-volume ratio, which promotes dispersibility in the emulsion, and are better adapted for multiple functions. As a result of reduced gravity force and Brownian motion, premature destabilization of this emulsion system is averted; hence, zero sedimentation during storage. Another destabilization factor, i.e., flocculation, is also prevented by the minuscule size of nanoemulsions, which prolongs the shelf-life of products. The small droplet size of nanoemulsions allows uniform deposition and penetration of active ingredients through the skin surface. Nanoemulsions exhibit better penetration efficacy of the ingredients due to the large surface area and low surface tension of the whole emulsion system, thus requiring only 3-10% of surfactants during preparation (Nur Haziqah Che Marzukia, 2019). Nanoemulsions are very similar to microemulsions that are dispersions of nano scale particles but obtained by mechanical force unlike to microemulsions which forms spontaneously. The combination of two theories, turbulence and cavitation, explain the droplet size reduction during the homogenization process of nano emulsions (Santosh Nemichand Kale, 2017).

Some commonly known preparation methods include: high energy emulsification (ultra-sonication, and high-pressure homogenization at very high pressure (500 to 5000 psi), high temperature and high energy); low energy emulsification (phase inversion temperature method where low temperature favors O/W emulsion and high temperature favors W/O emulsion; solvent displacement method and phase inversion composition method); microfluidization (high pressure (500 to 20000 psi); spontaneous emulsification; solvent evaporation technique; and a hydrogel method.

The differences between water in fuel (or oil) nanoemulsions when comparing to macro and/or microemulsions are often difficult to distinguish due to numerous and indistinct definitions characterizing nanoemulsions. Macroemulsions distinguish from all other emulsions due to their very low stability properties, hence defined as of high polydispersity. Some differences between water fuel macro-, micro- and nanoemulsions can be summarized as:
Micro- and nanoemulsions have smaller particle sizes than macroemulsions (nano-: 0.001* to ˜0.3 micrometer; micro-: <0.1 micrometer (usually 0.01-0.05 micrometer))
Micro- and nanoemulsions have a lower polydispersity index (PdI) than macroemulsions (nano-: >0.05*<0.10 (max <0.3); micro-: <0.10) *—based on laboratory tests performed and Dynamic Light Scattering (DLS) results using Malvern Zetasizer and Anton Paar Litesizer. Particle sizer greater than >99% for WFE with 22 and 28% water content @ Fn/W 0.375 and PdI for 8% water content at Fn/W 0.375, by mass. The greater the % W the higher the polydispersity of the WFE.
Micro- and nanoemulsions have a much longer shelf life than macroemulsions.
Free water tendency is not applicable to micro- and nanoemulsions.
Interfacial tension and emulsification energy are relatively low for both micro- and nanoemulsions compared to macroemulsions.

Standard emulsified fuels are normally macroemulsions of w/o type, also known as water in fuel emulsion (WFE), produced (in-line or batch) using local commercial fuels, mix of surfactants selected adopting the hydrophilic-lipophilic balance (HLB) method (prior-art), and water (ideally deionized), characterized by the particle size and polydispersity, varying respectively between 0.20 microns to 5 microns and 30% PdI or above, offered as ready-to-use (or short-term storage) alternative cost-effective cleaner fuel, most of the time wrongly classified as nanoemulsions.

A surfactant is an amphiphilic molecule consisting of a nonpolar hydrophobic part, usually a hydrocarbon chain, attached to a hydrophilic portion. Anionic surfactant head groups include sulphonate, sulphate, carboxylate, etc. Cationic surfactants, in which the head groups are positively charged, are generally molecules derived from substituted ammonium compounds. Most commonly used non-ionic surfactants are polysorbate and sorbitan ester surfactants, specifically and respectively, Tween 80 and Span 80 (both registered trademarks of Croda International PLC). Finally, surfactants in which the head group comprises of both anionic and cationic groups are termed zwitterionic surfactants. Most oil in water emulsions, specifically water in fuel nanoemulsions, include non-ionic surfactants.

Standard emulsion technology tends to use the concept of Hydrophilic-Lipophilic Balance (HLB) when choosing the surfactants to define the best chemical compositions. The principle is based on the HLB of a surfactant and their water loving and water hating nature. Surfactants with different ranges of HLB and their applications are shown in the table below:

| Ref. | HLB | Surfactant function |
|---|---|---|
| 1 | 2-3 | antifoaming agent |
| 2 | 3-6 | water in oil (w/o) emulsions |
| 3 | 7-9 | wetting and spreading agents |
| 4 | 8-16 | oil in water (o/w) emulsions |
| 5 | 13-15 | detergents |

Another method used to select the surfactants, not commonly known, and normally adopted for microemulsions is the hydrophilic lipophilic difference or deviation (HLD). For HLD=0, there is no difference between the hydrophilic tendency and the lipophilic tendency (Abbott, 2018). When HLD is higher than 0, emulsions with water as the dispersed phase can be produced with amounts as high as 70% by mass.

Parameters useful to evaluate micro emulsions used for comparative analysis of emulsion, micro emulsion and nano-emulsion are described by (Santosh Nemichand Kale, 2017).

Problems with water in fuel emulsions (WFE) relate to a lack of quality of the emulsified fuel and how it is used (offered). The primary reasons for WFE problems are a result of larger particle size (PS) and highly dispersed polydispersity (Pd) which not only affects the aspect (turbidity) but significantly adversely affects combustion efficiency. As a result, maximum power-torque loss increases, there is a higher specific fuel consumption rate and lower capability to reduce exhaust gas emission.

Problems also arise from the method and choice of surfactants, the use of single formulation in a wide range of different applications and conditions, that WFE are normally produced at ambient temperatures but used in different conditions, poor quality polydispersity, that high energy production methods are used, and that batch production results in variability between batches. A conventional WFE has low stability when produced as a ready-to-use fuel, which contributes to sedimentation, corrosion, and biodegradation, leading to the use of additional additives and WFE quality control measures.

It is an object of the present invention to improve the overall efficiency of fossil fuel combustion (such as petrol and diesel), particularly but not exclusively when applied to engines, machinery and equipment which perform internal, continuous and/or open flame combustion, and to enhance fuel consumption rates and reduce harmful gas emissions from the combustion of hydrocarbon, biodiesel and alcohol-based fuels and fuel blends.

### BRIEF SUMMARY OF THE INVENTION

The objective of the invention is a process for producing a microemulsion or nanoemulsion comprising: a) water and at least one hydrocarbon or oil, comprising the steps of: providing the hydrocarbon or oil, water, one or more additives, a solvent, and a hydrophilic surfactant formulation comprising an amine or amide derivative non-ionic surfactant which is a fatty acid alkanolamide, one or more ethoxylated alcohols and/or ethoxylated alkylphenols, and a non-ionic fatty acid ester; b) by a mixing or stirring device operating at a mixing or stirring speed in the range 100 rpm and 15000 rpm, mixing or stirring the hydrophilic surfactant formulation and additive into the solvent, to produce a hydrophilic self-emulsifying blend; c) adding water to the hydrophilic self-emulsifying blend and the hydrocarbon or oil to produce a water-in-hydrocarbon/oil microemulsion or nanoemulsion.

A microemulsion or nanoemulsion comprising: 46% or more by mass of hydrocarbon or oil as a continuous phase of the microemulsion or nanoemulsion, 4% to 36% by mass of liquid or gaseous water, a hydrophilic emulsifying blend of surfactant formulation, for mixing with water and hydrocarbon to form a microemulsion or nanoemulsion of water-in-hydrocarbon, the hydrophilic formulation to solvent mass ratio is in the range 1:3 to 1:5, having a HLB value greater than 9 and less than 15, comprising: 50% to 99% by mass of one or more non-ionic lauric fatty acid-based diethanolamides independently selected from a group comprising: cocamide DEA, lauramide DEA and palm kernelamide DEA; 25% to 50% by mass of one or more non-ionic fatty acid based alkanolamides, independently selected from the group comprising: acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA; one or both of: 1% to 30% by mass of at least one non-ionic fatty acid ester which is a sorbitan alkyl ester; 1% to 30% by mass of at least one non-ionic fatty acid ester which is a polyoxyethlyene derivative of a sorbitan alkyl ester; 1% to 70% by mass of one or more ethoxylated alcohols, ethoxylated alkylphenols and/or ethoxylated thiols; and 0.1% to 20% by mass of one or more further surfactants which are non-ionic, anionic, cationic or zwitterionic; in which the surfactant formulation to water mass ratio is in the range 1:5 to 1:2.5, 0.1% to 5% by mass of additive, and 1.2% or more by mass of solvent, in which the microemulsion or nanoemulsion has a dispersed particle size in the range 1 nm to 200 nm, and a polydispersity index of 30% PdI or less, wherein the percentages by mass of the hydrocarbon or oil, water, formulation, additive and solvent together add up to 100%.

A microemulsion or nanoemulsion of water-in-hydrocarbon, in which a surfactant formulation is selected to adjust the emulsifying blends of surfactant formulation, to operational temperatures of engine or machinery.

A microemulsion or nanoemulsion of water-in-hydrocarbon, for onboard applications to enhance combustion efficiency in engines and machinery, improving fuel consumption and reducing exhaust gas emissions.

### BRIEF DESCRIPTION OF THE SEVERAL VIEWS OF THE DRAWINGS

For a better understanding of the present invention, and to show more clearly how it may be carried into effect, reference will now be made by way of example only to the accompanying drawings, in which:

FIG. 1 shows a schematic of a plant or system for producing, and optionally correcting or adjusting in-line, stable water-in-fuel microemulsions and/or nanoemulsions;

FIG. 2 shows a schematic of a system for a vehicle for use in producing, and optionally correcting, emulsified fuel and a water-in-fuel microemulsion and/or nanoemulsion;

FIG. 3 shows a schematic of a second system for a vehicle, such as a truck, for producing and optionally correcting fuel flow containing any of a multiple-fuel, a gaseous fuel and a water-in-fuel microemulsion and/or nanoemulsion;

FIG. 4 shows an exploded side view of a low energy mixing or emulsification device (or “static mixer”) for creating or adjusting a microemulsion or nanoemulsion, for use in the system of FIG. 1;

FIG. 4A shows side views of sections of several different straight or curved conduits or housings which can be connected to one or more devices of FIG. 4 for providing a flow path in an apparatus;

FIG. 5 shows side views and end views of three types of turbulators which may be used in the device of FIG. 4, including a multiple-directional and conical-washer for use in the system of FIG. 1 or FIG. 2, spherical obstruction, and an additional flat turbulator for use in the system of FIG. 3;

FIG. 6 shows an end view and a cross-sectional view of a multi-directional turbulator;

FIG. 7 shows a cross-sectional side view of a second embodiment of a low energy mixing or emulsification device (or “static mixer”) for creating or adjusting a water-in-fuel microemulsion or nanoemulsion, for use in the system of FIG. 2;

FIG. 8 shows a perspective view of a third embodiment of a low energy mixing or emulsification device (or “static mixer”) for creating or adjusting a water-in-fuel microemulsion or nanoemulsion, for use in the system of FIG. 3;

FIG. 8A shows cross-sectional side view of the device of FIG. 8;

FIG. 8B shows a side view of a controlled injector and elements of the device of FIG. 8; and

FIG. 8C shows an exploded perspective view of the device of FIG. 8.

### DESCRIPTION OF PREFERRED EMBODIMENTS

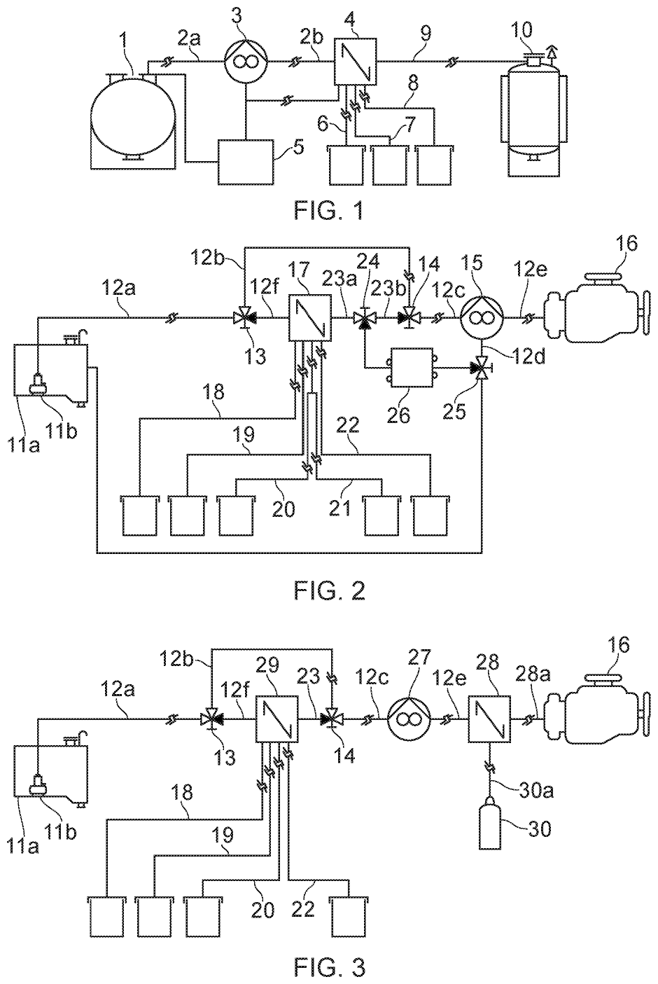

FIG. 1 shows a schematic of a modular production plant or system for producing microemulsion or nanoemulsion of water-in-solvent or water-in-HC/oil. The plant may be built in a single container or multiple 8″, 20″ or 40″ containers, for example. The plant is designed to treat water and produce blends, alcohol-based and ‘chemical’ solutions, and micro and/or nanoemulsions, and treat waste from the latter.

The plant includes a hydrocarbon or oil tank 1 for storing hydrocarbons (HC), and/or biodiesel and/or alcohol-based fuels and/or blends. A first flow conduit 2a connects the tank to a pump 3. A second flow conduit 2b leads to a mixing chamber or device 4.

In this embodiment, there is a control system 5 linked by the tank 1, pump 3 and mixing chamber 4 for controlling flow through the plant. The electronic control system has one or more sensors programmed to monitor various aspects of the system, and to adjust flow/dosing rates, temperature, and other parameters via manual input or automatically to meet predetermined operating parameters.

A first surfactant formulation tank and conduit 6 is connected to the mixer 4. The connection may be at an upstream position in this embodiment. The formulation in the tank 6 is a hydrophilic formulation, such as a formulation according to the third or fourth aspect of the invention.

A second surfactant formulation tank and conduit 7 is also connected to the mixer 4. The connection may be in a downstream position relative to the first formulation tank 6 in this embodiment. The formulation in the tank 7 is a lipophilic formulation, such as a formulation according to the fifth aspect of the invention.

A water reservoir or tank and conduit 8 are also connected to the mixer 4. The connection may be in a downstream position relative to the second formulation tank 7.

Suitable nozzles or other means for injecting or introducing the formulation, water etc. into the mixer device can be provided at inlets to the mixer device.

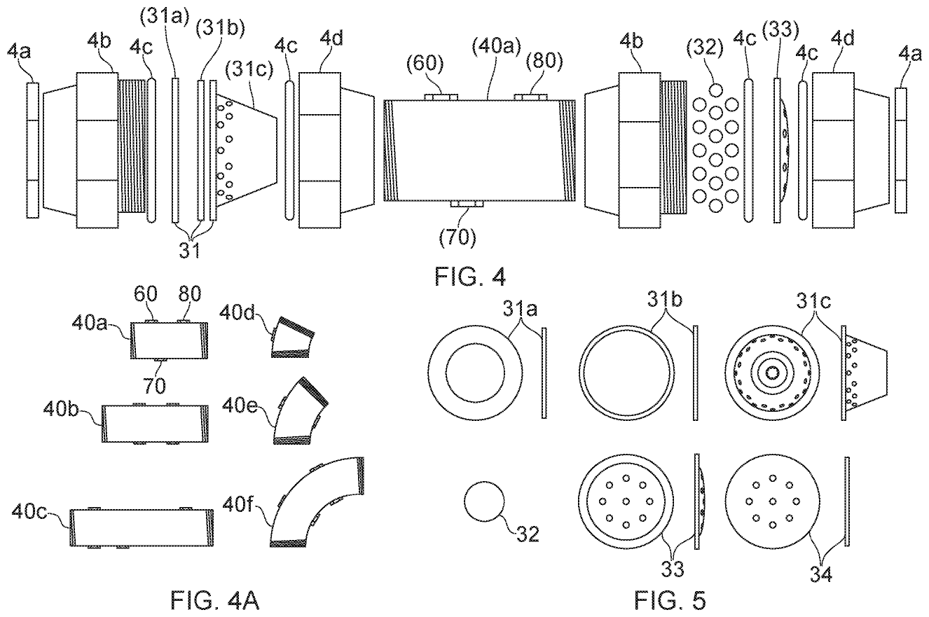

The mixer device 4 is used to mix or stir together the solvent (hydrocarbon or oil in this embodiment), formulations and water, thereby creating a microemulsion or nanoemulsion. Examples of suitable mixer devices are discussed later with respect to FIGS. 4 to 8C.

An outlet conduit 9 leads from the mixer device to an emulsion tank 10. The emulsion tank 10 is suitable for stably storing the microemulsion or nanoemulsion. The emulsion tank includes one or both of heating and cooling means to assist in maintaining micro- or nanoemulsion stability.

Other pumps, heating elements, sensors and/or actuators may be provided in any combination of the tanks and conduits for optimizing operation of the plant.

In variants of the FIG. 1 embodiment, the plant may include or utilize some or all of the following: a water treatment unit, water-based products such as chemical solutions and a nanoemulsion unit (water based), oil-based products such as fuel blends and a nanoemulsion unit, a desulphurization unit, a waste treatment unit, a power generation unit, and/or a production control and management unit.

FIG. 2 shows a schematic of an on-board system for a vehicle fuel system. The system may be considered to be a bi-fuel system configured for a low energy, continuous flow production method for producing or supplying, on-demand, pilot fuel, fuel blends and/or water-in-fuel micro- or nanoemulsions (WFE) with return, low and/or high-pressure fuel feeding and/or injection systems.

The system includes a fuel tank arrangement 11a, 11b, connected by a fuel line 12a, valve 13, 12b, valve 14, 12c, pump 15. The fuel if then lead by 12d back to the tank or 12e to the engine 16.

The system includes a fuel tank arrangement 11a, 11b, connected by a fuel line 12a, valve 13 and inlet conduit 12f to a mixer device 17.

A first surfactant formulation tank and conduit 18 is connected to the mixer 17. The connection may be at an upstream position in this embodiment. The formulation in the tank 18 is a hydrophilic formulation, such as a formulation according to the third or fourth aspect of the invention.

A second surfactant formulation tank and conduit 19 is connected to the mixer 17. The connection may be in a downstream position relative to the first formulation tank 18 in this embodiment. The formulation in the tank 19 is a lipophilic formulation, such as a formulation according to the fifth aspect of the invention.

A fuel blend tank and conduit 20 is connected to the mixer 17. The connection may be in a downstream position relative to the second formulation tank 19.

A solvent tank and conduit 21 is connected to the mixer 17. The connection is this embodiment meets the conduit 20 of the fuel blend tank such that the fuel blend and solvent enter the mixing chamber 17 via the same inlet.

A water reservoir or tank and conduit 22 is connected to the mixer 17. The connection to the mixing chamber 17 may be in a downstream position relative to the solvent tank connection.

Suitable nozzles or other means for injecting or introducing the formulation, water etc. into the mixer device can be provided at inlets to the mixer device.

The mixer device 17 is used to mix or stir together the solvent, hydrocarbon/oil, formulations, fuel blend and water, thereby creating a microemulsion or nanoemulsion. Examples of suitable mixer devices are discussed later with respect to FIGS. 4 to 8C.

An outlet conduit 23a from the mixer device 17 connects to a valve 24, leading into a further outlet conduit 23b connected to another valve 14. A second portion of outlet conduit 12c leads to a pump 15, which in turn connects to a vehicle engine 16 via fuel line 12e.

The pump 15 in this embodiment may be a return pump. The pump 15 may operate at relatively high pressure.

Emulsified fuel sent from line 23a, valve 24, emulsion line 23b, valve 14, line 12c, and pump 15, is therefore pumped with through line 12e to the engine 16.

The valve 25 includes a line 12d connected pumped through pump 15 and subsequent leads back to the fuel tank 11a, 11b.

The emulsion returned is connected through line 23a, valve 24, line 23b, valve 14, line 12c, pump 15, and straight into engine 16, through 12e.

The excess from pump 15 is sent to 12d to valve 25, leading to tank 26. The emulsion on tank 26, is then pumped through the first outlet valve 24, line 23b, valve 14, line 12c, pump 15, and straight into engine 16, through 12e.

FIG. 3 shows a schematic of another fuel system for a vehicle. Like numerals refer to like features in FIG. 2 unless otherwise apparent or described in different terms.

In this embodiment, there is no separate solvent tank and no separate emulsion tank. The mixer device connected to the formulation tanks 18, 19, fuel blend tank 20 and water tank 22 is labelled 29, and the pump is labelled 27.

A second mixer device 28 is connected to the fuel line 12e from the pump 27. The mixer device 28 is substantially similar to the first mixer device 29 in this embodiment and operates in a similar way. Examples of suitable mixer devices are discussed later with respect to FIGS. 4 to 8C.

A gas bottle or fuel container 30 is connected via conduit 30a to the second mixer device 28. This allows for the already-emulsified fuel from the first mixer device 29 to be further emulsified (such as to a G/W/G emulsion). An outlet conduit 28a from the mixer device 28 leads to the engine where the microemulsion or nanoemulsion from the mixer device 28 can be combusted.

FIG. 4 shows a first embodiment of a static mixer device for producing a water-in-solvent or water-in-fuel micro- or nanoemulsion.

The mixer device includes an inlet turbulator arrangement including a locking nut 4a, first inlet body 4b with an external thread, O-ring 4c, turbulator 31, second O-ring 4c and inlet body 4d with an internal thread (not visible) for receiving the external thread to enclose the turbulator 31. The turbulator 31 includes a frustoconical portion 31c which has a plurality of perforations or apertures for flow to pass through during use. The apertures are in the tapering wall of the frustoconical portion, preferably at the wide end as in this embodiment. The narrow end of the frustoconical portion may be closed or have some perforations (see FIG. 5). The turbulator also includes annulus 31a and annulus 31b which fit proximate to a circumferential flange at the wide end of the frustoconical portion.

A mixing or emulsifying chamber 40a is fluidly connected to the inlet turbulator arrangement. Nozzles or other inlet or injection means 60, 70, 80 for introducing various constituents (formulation, water, solvent and so on) for the micro- or nanoemulsion may connect to the lengths of conduit at any suitable location.

The mixer device includes an outlet turbulator arrangement leading from an outlet end of the mixing chamber 40a. The outlet turbulator arrangement includes a first outlet body 4b with external thread, a plurality of spheres 32 disposed within the first O-ring 4c, a relatively flat-domed or plate-like turbulator 33 with circumferential flange for the O-ring 4c, and a second outlet body 4d with an internal thread (not visible) for receiving the external thread to enclose the turbulator 33, followed by a locking nut 4a.

FIG. 4A shows three different lengths of linear conduit 40a, 40b, 40c that may be used for the mixing chamber. FIG. 4A also shows three different lengths of curved conduit 40d, 40e, 40f that may be used for the mixing chamber. Any of these conduits may also be used in combination to convey the mixture to another mixing chamber.

FIG. 5 shows the turbulator elements 31, 33 in more detail, along with one of the spheres 32. The inlet turbulator 31 has a washer or wide annulus 31a, an O-ring or narrow annulus 31b, and a perforated frustoconical turbulator body 31c. The outlet turbulator 33 has the slightly domed, perforated body discussed previously. However, a variant is the flat plate turbulator 34 with a plurality of perforations.

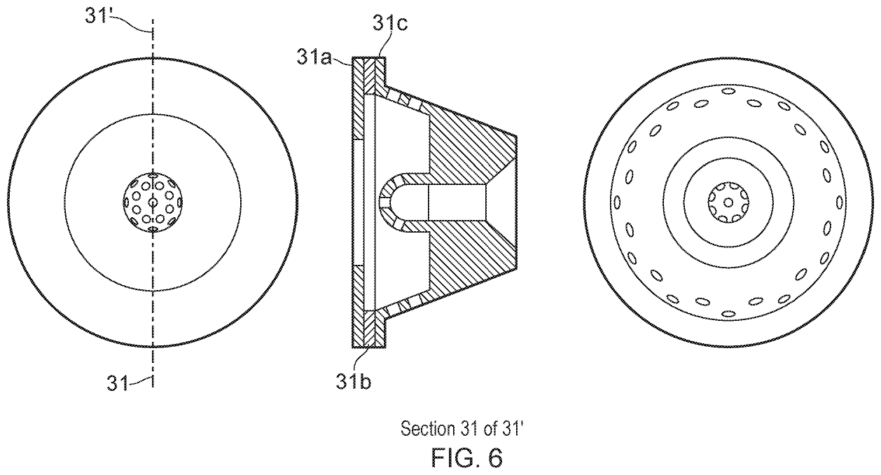

FIG. 6 shows a variant embodiment of a ‘multidirectional’ frustoconical turbulator element 31 in further detail. The element 31 can be seen to have a relatively narrowed inlet by virtue of the washer 31a, which expands into a sub-chamber at the wide end of the frustoconical element. In addition to the perforations in the frustoconical wall of the turbulator element 31, there is also a central perforated portion with a longitudinal conduit and outlet through the narrow end of the frustoconical portion. This also some flow to continue along a substantially axial flow path, whilst the remaining flow takes a substantially radial diversion before returning to flow in an axial direction having passed through the frustoconical wall.

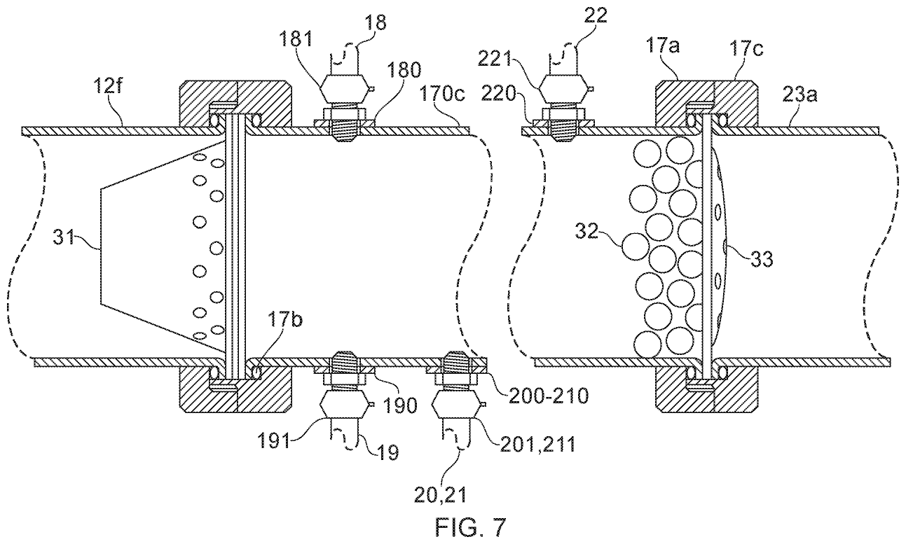

FIG. 7 shows a second embodiment of a static mixer device for producing a water-in-solvent or water-in-fuel micro- or nanoemulsion.

In this embodiment, the inlet turbulator is oriented in the opposite manner to that of FIG. 4. Whereas is FIG. 4 the wide end of the turbulator is oriented receive inlet flow, the narrow end of the frustoconical turbulator 31 is oriented towards the inlet and the wider perforated end is disposed proximate to the mixing chamber 170c. The structure may otherwise be considered to be substantially similar, although there may be some differences for flow regulation purposes.

Seals or O-rings 17b are provided for ensuring a good fluid seal around the turbulator 31. Threaded bodies 17a, 17c are threadingly connected to compress the seals 17b.

The outlet turbulator arrangement 32, 33 to 34 is substantially similar to that already described for FIG. 4.

Nozzles or injectors 181, 191, 201, 221 corresponding to each of the tanks 18, 19, 20, 22 in FIG. 2 are provided for spraying or injecting formulation, water, solvent and so on into the mixing chamber.

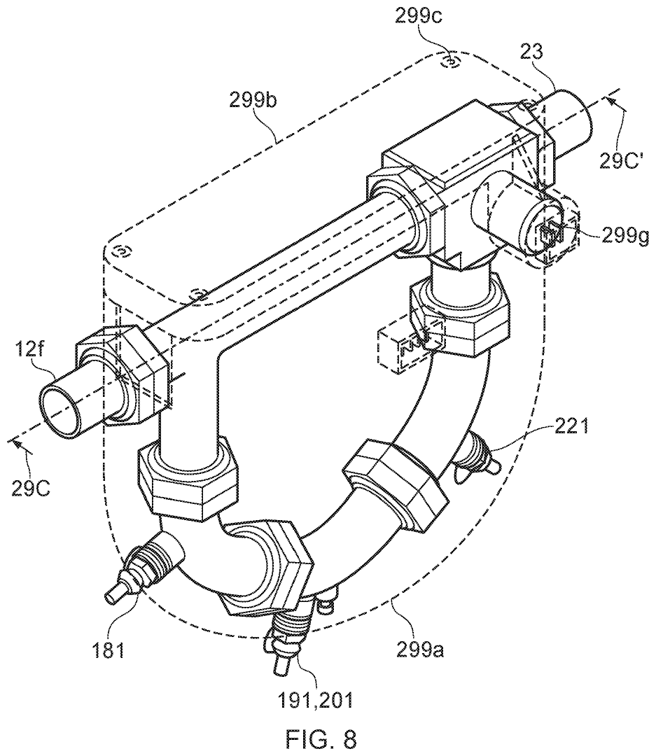

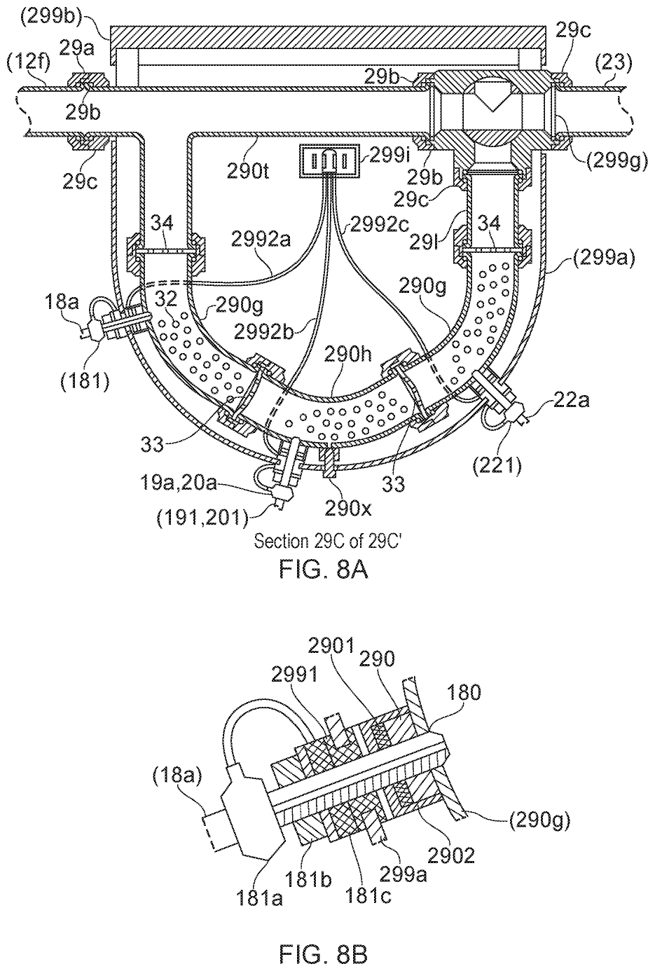

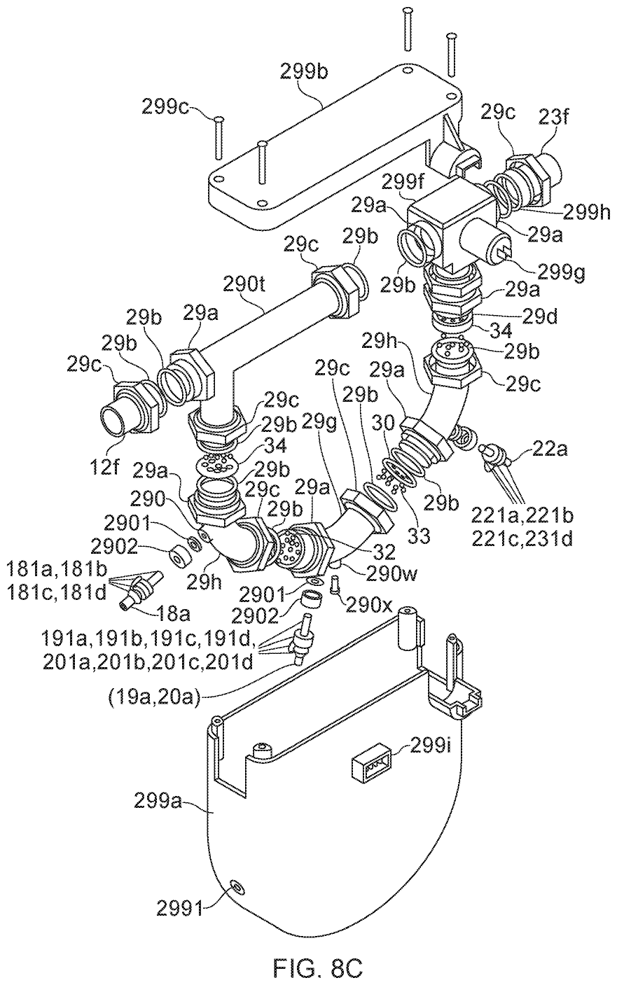

FIGS. 8 to 8C show another embodiment of a mixer device, which is substantially U-shaped. In this embodiment, the mixer device includes a modular arrangement of the sections in FIG. 4A, providing two flow paths—a non-diverted flow path which is substantially a conventional fuel line, and a diverted flow path which includes mixer chambers and dosing nozzles, and rejoins the fuel line downstream (in this embodiment at a valve arrangement). The turbulators and conduit sections are all sealingly engaged in the following arrangement.

The U-shaped section of the mixing device includes a straight section of conduit which is arranged perpendicular to the fuel line 29b. Flow passes through a first perforated turbulator plate 34 and into a curved conduit section 290g containing spheres 32. A nozzle 18a can dose a first (hydrophilic) surfactant formulation into the mixing chamber in that curved conduit.

A second perforated turbulator element 33 is provided further along the flow path, and flow passes through that into another curved conduit 290h containing spheres 32. Dosing nozzles 19a, 20a are connected to the conduit 290h for dosing a second (optionally lipophilic) surfactant formulation and/or fuel blend into the mixture.

A drain port arrangement 290x is provided at a lowermost point of the mixer device.

A third perforated turbulator element 33 is provided yet further along the flow path, and flow passes through that into another curved conduit 290g containing spheres 32. Dosing nozzle 221 is connected to the conduit 290g for dosing water into the mixture.

The mixture passes through another turbulator element 34 to produce a micro- or nanoemulsion of water-in-fuel. The micro- or nanoemulsion rejoins the fuel line 23 via the valve. This arrangement thus provides in-line production of the WFE.

A controller 299i controls dosing via the nozzles to control the composition and structure of the micro- or nanoemulsion during use.

Port 299g can be used to introduce another constituent to the flow such as a microemulsion or nanoemulsion from the emulsion tank if the arrangement is like that in FIG. 2, or a gas or fuel from a container 30 like that in the arrangement in FIG. 3.

A housing 299a is provided around U-shaped arrangement of the turbulators and conduit sections. It will be appreciated that the series of turbulators and conduits may be of any suitable shape, such as C-shaped, looped or helical, or another irregular shape, and it is not necessary for the arrangement to be U-shaped.

A lid 299b can be connected to the top of the housing 299a and secured in place by screws 299c.

Whilst FIG. 8B shows the construction of a dosing nozzle in more detail, any suitable conventional nozzle may be used.

In any of the above embodiments, one or more pre-mixing chambers may be provided. The arrangement in FIGS. 8-8C provides a series of mixing chambers, some of which may be considered as pre-mixing chambers to homogenize the various components in a stepwise manner prior to emulsification.

### Formulation Embodiments

The composition of exemplary formulations are as follows:

Embodiment 1: 100% by mass of a hydrophilic amine and amide derivative non-ionic surfactants, selected from fatty acid alkanolamides, of the total mass of the chemical formulation (Fn); selected among, but not limited to, group I, for example, almondamide DEA, cocamide DEA, cocamide DIPA, cocamide MEA, cocamide MIPA, lauramide DEA, lauramide MEA, lauramide MIPA, palm kernelamide DEA, palm kemelamide MEA and palm kernelamide MIPA particularly, cocamide DEA, lauramide DEA, palm kernelamide DEA and palm kemelamide MEA more particularly, cocamide DEA.
Embodiment 2: from 25% to 99% by mass of a hydrophilic surfactant, as defined in embodiment 1 (particularly from 50% to 99%, more particularly above 75%) and from 1 to 30% by mass of a lipophilic fatty acid esters non-ionic co-surfactants, particularly from 1% to 20%, of the total mass of the chemical formulation (Fn); selected among, but not limited to, group III, specifically sorbitan alkyl esters (Spans), for example, sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85), particularly sorbitan monostearate (Span 60), sorbitan tristearate (Span 65), Sorbitan monooleate (Span 80), more particularly, Sorbitan monooleate (Span 80). Embodiment 3: from 25% to 99% by mass of a hydrophilic surfactant and from 1% to 30% by mass of lipophilic co-surfactants, as defined in embodiment 2, and from 1% to 70% by mass of an amphiphilic ethoxylated alcohols and/or alkylphenols non-ionic co-co-surfactants, particularly from 1% to 40%, more particularly from 1% to 25%, selected from ethoxylated linear alcohols, ethoxylated alkyl phenols surfactant and/or ethoxylated thiols, of the total mass of the chemical formulation (Fn); selected among, but not limited to, group II, for example, nonylphenol ethoxylate and/or alcohol ethoxylate, particularly, nonylphenol ethoxylate EO-6.
Embodiment 4: from 25% to 99% by mass of a hydrophilic surfactant and from 1% to 30% by mass of lipophilic co-surfactants, as defined in embodiment 2, and from 0.1% to 20% by mass of other non-ionic, anionic, cationic, zwitterionic and/or any other co-co-surfactants, particularly from 1% to 10%, more particularly from 1% to 5%, of the total mass of the chemical formulation (Fn); selected among, but not limited to, group II and/or IV, for example, almondamidopropyl betaine, apricotamidopropyl betaine, capryl/capramidopropyl betaine, canolamidopropyl betaine, cocamide betaine, cocamidoethyl betaine, cocamidopropyl betaine, cocamidopropyl hydroxysultaine, coco-betaine, coco-hydroxysultaine, Cocamidopropyl Hydroxysultaine, coconut alcohol, coco/oleamidopropyl betaine, Cocamidopropylamine Oxide, Cocamidopropylamine Oxide, decyl betaine, hydrogenated tallow betaine, Lauramide Oxide, Lauramidopropylamine Oxide, lauramidopropyl betaine, lauryl betaine, myristamidopropyl betaine, oleamidopropyl betaine, oleyl betaine, palm kernelamidopropyl betaine, palm amidopropyl betain, palmitamidopropyl betaine, sesamidopropyl betaine, soyamidopropyl betaine, stearyl betaine, tallowamidopropyl betaine, octylphenoxy polyethoxyethanol (triton x-100), tetradecyltrimethylammonium bromide (TTAB), Sodium lauryl sulfoacetate and/or sodium dodecyl sulphate, and/or acetamide MEA, apricotamide DEA, avocadamide DEA, avocadamide DIPA, babassuamide DEA, babassuamide MEA, Capramide DEA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA.
Embodiment 5: from 25% to 99% by mass of a hydrophilic surfactant, from 1% to 30% by mass of lipophilic co-surfactants and from 1% to 70% by mass of an amphiphilic co-co-surfactants, as defined in embodiment 3, and from 0.1% to 20% by mass of other co-co-surfactants, of the total mass of the chemical formulation (Fn), as defined in embodiment 4.
Embodiment 6: from 25% to 99% by mass of a hydrophilic surfactant, from 1% to 30% by mass of lipophilic co-surfactants, from 1% to 70% by mass of an amphiphilic co-co-surfactants and from 0.1% to 20% by mass of other co-co-surfactants, of the total mass of the chemical formulation (Fn), as defined in embodiment 5, and from 1% to 70% by mass of a hydrophilic fatty acid esters non-ionic co-surfactants, particularly from 1° A to 50%, more particularly from 5% to 40% of the total mass of the chemical formulation (Fn); selected among, but not limited to, group III, specifically polyoxyethlyene derivatives of sorbitan alkyl esters (Tweens), for example), polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85), particularly, polyoxyethylene sorbitan monopalmitate (Tween 40), polyoxyethylene sorbitan monostearate (Tween 60), polyoxyethylene sorbitan monooeleate (Tween 80) and more particularly, polyoxyethylene sorbitan monooeleate (Tween 80).
Embodiment 7: from 25% to 99% by mass of a hydrophilic surfactant, from 1% to 70% by mass of a hydrophilic co-surfactants and from 1% to 30% by mass of a lipophilic co-surfactants, of the total mass of the chemical formulation (Fn), as defined in embodiment 6.
Embodiment 8: from 25% to 99% by mass of a hydrophilic surfactant, from 1% to 70% by mass of a hydrophilic co-surfactants and from 1% to 30% by mass of a lipophilic co-surfactants, of the total mass of the chemical formulation (Fn), as defined in embodiment 6, and from 0.1% to 20% by mass of other co-co-surfactants, of the total mass of the chemical formulation (Fn), as defined in embodiment 4.

The embodiments described above are provided by way of example only, and various changes and modifications will be apparent to persons skilled in the art without departing from the scope of the present invention as defined by the appended claims.

### DETAILED DESCRIPTION OF THE INVENTION

The present invention relates to the field of emulsified fuels, information technology, energy, and performance management for improving the efficiency of engines, machinery and/or equipment, including but not limited to types of internal, continuous and open flame combustion equipment. The object of the invention is to enhance specific fuel consumption rates, reduce power-torque loss, and/or reduce the emissions produced from the consumption and burning of hydrocarbon, biodiesel and alcohol-based fuels, other fuels and blends.

According to a first aspect of the present invention, there is provided a method as claimed in claim 1. Optional features are presented in the dependent claims.

The method has the advantage of producing a micro-emulsion or nanoemulsion which can be used to significantly improve combustion efficiency of diesel and other fuels, reducing harmful emissions.

The surfactant formulation may include at least two hydrophilic surfactants with a HLB value higher than ten (>10), such as polyoxyethylene sorbitan monooleate and a coconut fatty acid amide of ethanolamine, commercially known as Cocamide DEA.

The surfactant formulation may include at least one lipophilic co-surfactant with a HLB value lower than 9, such as sorbitan monooleate.

The surfactant formulation may include at least co-co-surfactants, or agents, with a mid-range HLB value of greater than 9 and less than 10.

The emulsion may be a water-in-solvent emulsion. The solvent may or may not be a hydrocarbon or oil. The solvent may be a non-polar solvent. The invention is more generally applicable to microemulsion and nanoemulsion comprising water-in-solvent.

Where a second emulsifying blend is provided, as in claim 2, this is useful as a means of ‘correcting’ the properties of the main microemulsion or nanoemulsion. For example, it can be used to compensate for changes system parameters, where such parameters are monitored e.g. by an electronic system. The system may then dose the second emulsifying blend in a suitable amount. In some embodiments, the second emulsifying blend may be prepared according to monitored conditions.

The particle size range may be in the range 1 to 200 nm. The particle size range may be in the range 1 to 100 nm. The particle size range may be in the range 1 to 50 nm.

The fatty acid alkanolamine may include a non-ionic lauric acid based surfactant.

The process may be a continuous flow process. The process may be a batch process. The process may be a dilution production method.

The HLB value of the formulation may be in the range 10 to 15, or 11 to 15.

The first surfactant formulation may be the surfactant formulation of the third or fourth aspects of the invention. The second surfactant formulation may be the surfactant formulation of the fifth aspect of the invention.

According to a second aspect of the invention, there is provided an apparatus for providing a microemulsion or nanoemulsion in a hydrocarbon flow or oil flow as claimed in claim 5. Optional features are presented in the dependent claims.

The apparatus can be used to produce water-in-fuel micro- or nanoemulsion, either for immediate use or for a short-term storage period. Where the apparatus is installed in a vehicle, this may be considered to be on-board production. In particular, the apparatus operates using the existing fuel pump (when provided as part of a fuel system) and no additional pump is needed for aiding operation of the mixer device, which operates under relatively low energy conditions. In use, flow of the existing fuel in the system creates low pressure and high turbulence in the mixing and/or emulsifying chamber with a minimum pressure differential between the inflow and the outflow.

The flow pressure in the apparatus may be around 1 MPa or less, or around 800 kPa or less.

If mixing means is provided as in claim 6, for mixing the surfactant formulation and water with the hydrocarbon or oil to form the microemulsion or nanoemulsion, this can allow ‘on-board’ or on demand preparation of a suitable microemulsion or nanoemulsion. The amounts of surfactant formulation and water may be selected by means of an electronic system, for example.

A pre-made microemulsion or nanoemulsion (rather than made on-demand in the apparatus) may be stored in an emulsion tank for introducing the microemulsion or nanoemulsion into the flow.

One or more nozzles, or preferably at least two nozzles, may be connected to the surfactant formulation tank and the water tank for dosing surfactant formulation and water into the feed line or mixing chamber. This may be used to form a water-in-hydrocarbon or water-in-oil microemulsion or nanoemulsion.

At least one additional hydrocarbon or oil tank may be provided. Blending means may be provided and configured to receive hydrocarbon or oil from the tanks and blend them together for feeding into the mixing chamber. This can allow for a fuel blend to be produced which has better properties for forming a microemulsion or nanoemulsion.

A fuel blend may in one aspect comprise:

from 5% to 95% by mass of a pilot fuel, comprising hydrocarbon, biodiesel and/or alcohol-based fuels and/or fuel blends, of the total mass of the fuel blend;

from 5% to 95% by mass of hydrocarbon, biodiesel, alcohol, and/or other solvents, of the total mass of the fuel blend;

from 5% to 95% by mass of liquid gas, selected from light naphtha, butane and/or any other gaseous fuel in liquid form between 10 at 50° C. and pressure between ambient to at least 40 Bar, of the total mass of the fuel blend;

from 1% to 20% by mass of additives and/or other chemical compounds, of the total mass of the fuel blend.

There may be six or more spheres or obstructions in the outbound portion of the flow path, for maximizing turbulence in outbound flow.

The apparatus may include a return conduit for receiving return flow, e.g. for fuel that has not been combusted in a fuel system. The return conduit may feed into the feed line or the mixing chamber. The amount or composition of the formulation being introduced to the chamber during use may be adjusted to compensate for the composition of the contents of the return flow. The adjustment may be done manually, or automatically where a monitoring device or system is provided.

The apparatus may be connected to any suitable fuel system, such as a fuel system for an engine, generator, turbine, burner, or other combustion device for enhancing fuel combustion efficiency. The apparatus or the system it connects to may be an open-loop controlled system, or a closed-loop controlled system.

According to a third aspect of the present invention, there is provided a surfactant formulation for mixing with water and a solvent to form a microemulsion or nanoemulsion of water-in-solvent as claimed in claim 10. Optional features are presented in the dependent claims.

The advantages are similar to those for the preceding aspects of the invention.

In some embodiments, the formulation may have a particle size range of 1 nm to 200 nm and 30% POI or less. The formulation may be produced in a continuous flow process. In some embodiments, the formulation may comprise 50% to 95% by mass of a hydrocarbon; 5% to 30% by mass of water in liquid or gaseous phase; formulation:water mass ratio in the range 1:5 to 1:2.5 (or 1:4 to 1:2.5); 0.1% to 5% by mass of a chemical compositions; and 1.2% to 90% by mass of a solvent.

The sorbitan alkyl ester may be independently selected from a group comprising: sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85). Span 80 is preferred in some embodiments.

The polyoxyethlyene derivative of the sorbitan alkyl ester may be independently selected from a group comprising: polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85). Tween 80 is preferred in some embodiments.

The ethoxylated alcohol may be alcohol ethoxylate. The ethoxylated alkylphenol may be nonylphenol ethoxylate.

The one or more further surfactants may be independently selected from group

(a) in claim 10. Additionally, or alternatively, the one or more further surfactants may be independently selected from the group (b) comprising:
b) almondamidopropyl betaine, Alkyl polyethylene glycol ether, apricotamidopropyl betaine, capryl/capramidopropyl betaine, canolamidopropyl betaine, cetearyl Alcohol, cetrimonium bromide, cocamide betaine, cocamidoethyl betaine, cocamidopropyl betaine, cocamidopropyl hydroxysultaine, coco-betaine, coco-hydroxysultaine, coconut alcohol, coco/oleamidopropyl betaine, Cocamidopropylamine Oxide, decyl betaine, glyceryl stearate SE, Glyceryl Caprylate/Caprate, hydrogenated tallow betaine, Lauramide Oxide, Lauramidopropylamine Oxide, lauramidopropyl betaine, lauryl betaine, Lauryl/Myristyl Amidopropyl Amine Oxide, lauryl alcohol ethoxylates, myristamidopropyl betaine, oleamidopropyl betaine, oleyl betaine, palm kernelamidopropyl betaine, palmidopropyl betain, palmitamidopropyl betaine, propylene glycol stearate, sesamidopropyl betaine, soyamidopropyl betaine, stearyl betaine, tallowamidopropyl betaine, trilaneth-4 phopshate, octylphenoxy polyethoxyethanol (triton x-100), tetradecyltrimethylammonium bromide (TTAB), Sodium lauryl sulfoacetate, Sodium cetearyl sulfate, and sodium dodecyl sulphate.

According to a fourth aspect of the invention, there is provided a hydrophilic surfactant formulation for mixing with water and a solvent to form a microemulsion or nanoemulsion of water-in-solvent, the surfactant formulation comprising:

50% to 100% by mass of one or more non-ionic fatty acid based alkanolamides which are hydrophilic amine and amide derivative non-ionic surfactants independently selected from a group comprising: almondamide DEA, cocamide DEA, cocamide DIPA, cocamide MEA, cocamide MIPA, lauramide DEA, lauramide MEA, lauramide MIPA, palm kernelamide DEA, palm kernelamide MEA and palm kernelamide MIPA;

and optionally one or more of the following:
a) 30% to 70% by mass of one or more hydrophilic fatty acid esters non-ionic surfactants which are one or more polyoxyethlyene derivatives of sorbitan alkyl esters (Tweens);
b) 1% to 30% by mass of one or more lipophilic fatty acid esters non-ionic surfactants which are one or more sorbitan alkyl esters (Spans);
c) 1% to 50% by mass of one or more further amphiphilic or hydrophilic non-ionic surfactants, optionally selected from a group comprising: acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA.

The advantages are similar to those for the preceding aspects of the invention.

According to a fifth aspect of the invention, there is provided a lipophilic surfactant formulation for adjusting a HLB value of a microemulsion or nanoemulsion of water-in-solvent formed using a hydrophilic surfactant formulation, the lipophilic surfactant formulation comprising:

1% to 20% by mass of one or more non-ionic fatty acid based alkanolamides which are hydrophilic amine and amide derivative non-ionic surfactants independently selected from a group comprising: almondamide DEA, cocamide DEA, cocamide DIPA, cocamide MEA, cocamide MIPA, lauramide DEA, lauramide MEA, lauramide MIPA, palm kernelamide DEA, palm kernelamide MEA and palm kernelamide MIPA;

1% to 10% by mass of one or more hydrophilic fatty acid esters non-ionic surfactants which are one or more polyoxyethlyene derivatives of sorbitan alkyl esters (Tweens);

50% to 100% by mass of one or more lipophilic fatty acid esters non-ionic surfactants which are one or more sorbitan alkyl esters (Spans);

1% to 50% by mass one or more further lipophilic non-ionic surfactants, optionally selected from a group comprising: acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA.

Advantageously, this lipophilic formulation can be used in combination with the hydrophilic formulation of the fourth aspect. It can be used to modify the conditions in the mixing or emulsifying process, and thus control the properties and composition of the resulting micro- or nanoemulsion.

According to a sixth aspect of the invention, there is provided a microemulsion or nanoemulsion comprising:

46% to 95.6% by mass of hydrocarbon or oil as a continuous phase of the microemulsion or nanoemulsion,

4% to 36% by mass of liquid or gaseous water,

a surfactant formulation according to any of the third, fourth and/or fifth aspects of the invention, in which the formulation to water mass ratio is in the range 1:10 to 1:2,

0.1% to 5% by mass of additive or chemical composition, and

1.2% to 90% by mass of solvent,

in which the microemulsion or nanoemulsion has a dispersed particle size in the range 1 nm to 500 nm, and a polydispersity index of 35% PdI or less.

Where the formulations of the fourth and fifth aspects are provided in a micro- or nanoemulsion for an oil-based blend, they may comprise 16.7% to 25% by mass of the total mass of blend.

One or more containers may be provided which comprise either the surfactant formulation of any of the third, fourth and/or fifth aspects of the invention, or comprise a microemulsion or nanoemulsion according to the sixth aspect of the invention.

According to seventh aspect of the invention, there is provided a mixer or emulsifier device for use in making a microemulsion or nanoemulsion of water-in-solvent. The device is designed to create high turbulence within a mixing and emulsifying chamber. This is to produce one or more oil-based blends or micro- or nanoemulsions of different morphology, at suitable density, viscosity, velocity and pressure.

The device may be used in an off-board process (e.g. in a production plant) or onboard process (e.g. in a vehicle). The device may be used in a single or multiple phase process, which may be a continuous flow process.

The device may be single or multi-chambered. The device may be an in-line device.

The outflow:inflow pressure differential (across the chamber, for example) may be up to around 1:3. Preferably it is not lower than 1:1. In some embodiments, the outflow:inflow pressure differential may be greater than 1:3.

The device may be modular. The device may be considered to be a ‘static’ mixer, which may not have moving parts.

The device may include a metal or plastic housing. The housing may provide a mixing and/or emulsifying chamber. Ends of the housing may be threaded for connection to a flow line, for example.

One or more threaded holes may be provided in the housing for connecting one or more dosing nozzles, such as electronic controlled solenoid dosing nozzles.

The housing may include one or more linear tubular sections. Each section in the housing may have one of at least 3 different lengths. The sections may each have a length:diameter ratio varying from 2:1 to 5:1.

The housing may include one or more curved tubular sections. The curvature of each section in the housing may be one of at least 3 different angles, which may be selected from angles in the range 30° to 90°.

This allows for modular construction of the device using curved and/or straight conduits to direct flow between parts of a fuel system or from an upstream mixer device to a downstream mixer device connected in series, for example.

Suitable L/R female-male connecting nuts may be provided for connecting the device to a fuel supply system.

The device may include one or more nozzles, which may be selected to be a flat or conical washer type nozzle. There may be a multidirectional nozzle. The device may include a turbulence-enhancing washer or component, for example.

The device may include one or more turbulators or turbulator nozzles.

The device may include a plurality of spheres or obstructions at or towards an outlet end of the chamber for increasing flow turbulence. Preferably there are at least six sphere-like obstructions.

According to a seventh aspect of the invention, there is provided a system comprising the apparatus of the second aspect of the invention or a mixing or emulsifying device according to the seventh aspect of the invention, for carrying out the process of the first aspect of the invention using the surfactant formulation of third aspect of the invention and/or the surfactant formulations of fourth and fifth aspects of the invention.

Any feature or features presented with respect to one aspect of the invention may be provided in any other aspect of the invention.

Any of a hydrocarbon, a biodiesel and an alcohol-based fuel may be provided as fuel for the continuous phase for the microemulsion or nanoemulsion.

Where water is used, the water may be deionised water or demineralized water. However, some embodiments may include tap water, desalinised water, or water vapour, for example.

For the purpose of the invention, hydrocarbon, biodiesel and alcohols fuels, blends and/or other liquids from petroleum, vegetable and/or animal source, and/or other chemical compounds, may be used as solvents, and/or improvers for pilot fuel and/or specially produced blends, e.g. to dilute the chemical formulation (Fn) for onboard production applications.

A performance management system may be provided for monitoring the process, system or apparatus of preceding aspects of the invention, and adjusting the process or operation of the system or apparatus for achieving predetermined operational parameters. For example, a formulation blend may be adjusted to contain a greater or lesser proportion of lipophilic formulation depending on the operation of a vehicle.

In another aspect of the invention, there is provided a surfactant formulation, exhibiting a high HLB value greater than 9 and less than 15, comprising:

50% to 100% by mass, of one or more hydrophilic non-ionic lauric fatty acid alkanolamide, preferably selected from surfactant group 1, DEA, cocamide DEA, cocamide DIPA, cocamide MEA, cocamide MIPA, lauramide DEA, lauramide MEA, lauramide MIPA, palm kernelamide DEA, palm kemelamide MEA and palm kernelamide MIPA, particularly, cocamide DEA, lauramide DEA, palm kernelamide DEA and palm kemelamide MEA more particularly, cocamide DEA;

1% to 30% by mass, of one more lipophilic non-ionic fatty acid esters, particularly, sorbitan alkyl esters, preferably selected from surfactant group 2;

30% to 70% by mass, of one or more hydrophilic non-ionic fatty acid esters, particularly, polyoxyethlyene derivatives of sorbitan alkyl esters, preferably selected from surfactant group 3;

1% to 25%, by mass, of at least one ethoxylated alcohols and/or alkylphenols, preferably selected from surfactant group 4;

1% to 50% by mass, of one or more surfactant preferably selected from surfactant group 6.

In another aspect of the invention, there is provided a surfactant formulation, exhibiting a high HLB value greater than 1 and less than 9, comprising:

1% to 20% by mass, of one or more hydrophilic non-ionic lauric fatty acid alkanolamide, preferably selected from surfactant group 1, DEA, cocamide DEA, cocamide DIPA, cocamide MEA, cocamide MIPA, lauramide DEA, lauramide MEA, lauramide MIPA, palm kernelamide DEA, palm kemelamide MEA and palm kernelamide MIPA, particularly, cocamide DEA, lauramide DEA, palm kernelamide DEA and palm kemelamide MEA more particularly, cocamide DEA;

50% to 100% by mass of one more lipophilic non-ionic fatty acid esters, preferably sorbitan alkyl esters, preferably selected from surfactant group 2;

1% to 10% by mass of one or more hydrophilic non-ionic fatty acid esters, preferably polyoxyethlyene derivatives of sorbitan alkyl esters, preferably selected from surfactant group 3;

1% to 40% by mass of at least one ethoxylated alcohols and/or alkylphenols, preferably selected from surfactant group 4;

1% to 50% by mass of one or more surfactants preferably selected from surfactant group 6.

Any one or more surfactants from the following groups may be independently selected for inclusion in the surfactant formulation in any of the aspects of the invention.

### Surfactant Group 1:

One or more amine and/or amide derivative non-ionic surfactants independently selected from one or more fatty acid alkanolamides in the group comprising: acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA.

### Surfactant Group 2:

One or more fatty acid esters non-ionic co-surfactants independently selected from one or more sorbitan alkyl esters (Spans) in the group: sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85).

### Surfactant Group 3:

One or more fatty acid esters non-ionic co-surfactants independently selected from one or more polyoxyethlyene derivatives of sorbitan alkyl esters (Tweens) from the group comprising: polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85).

### Surfactant Group 4:

One or more ethoxylated alcohols and/or alkylphenols non-ionic co-co-surfactants, independently selected from the group comprising: one or more ethoxylated linear alcohols, ethoxylated alkylphenols and/or ethoxylated thiols, such as nonylphenol ethoxylate and alcohol ethoxylate.

### Surfactant Group 5:

One or more non-ionic, anionic, cationic, zwitterionic (amphoteric) and/or other surfactants independently selected from the group comprising: almondamidopropyl betaine, Alkyl polyethylene glycol ether, apricotamidopropyl betaine, capryl/capramidopropyl betaine, canolamidopropyl betaine, cetearyl Alcohol, cetrimonium bromide, cocamide betaine, cocamidoethyl betaine, cocamidopropyl betaine, cocamidopropyl hydroxysultaine, coco-betaine, coco-hydroxysultaine, Cocamidopropyl Hydroxysultaine, coconut alcohol, coco/oleamidopropyl betaine, Cocamidopropylamine Oxide, Cocamidopropylamine Oxide, decyl betaine, glyceryl stearate SE, Glyceryl Caprylate/Caprate, hydrogenated tallow betaine, Lauramide Oxide, Lauramidopropylamine Oxide, lauramidopropyl betaine, lauryl betaine, Lauryl/Myristyl Amidopropyl Amine Oxide, lauryl alcohol ethoxylates, myristamidopropyl betaine, oleamidopropyl betaine, oleyl betaine, palm kernelamidopropyl betaine, palmamidopropyl betain, palmitamidopropyl betaine, propylene glycol stearate, sesamidopropyl betaine, soyamidopropyl betaine, stearyl betaine, tallowamidopropyl betaine, trilaneth-4 phopshate, octylphenoxy polyethoxyethanol (triton x-100), tetradecyltrimethylammonium bromide (TTAB), Sodium lauryl sulfoacetate, Sodium cetearyl sulfate and/or sodium dodecyl sulphate.

### Surfactant Group 6:

One or more non-ionic, anionic, cationic, zwitterionic (amphoteric) and/or any other surfactants independently selected from the group comprising: almondamidopropyl betaine, apricotamidopropyl betaine, capryl/capramidopropyl betaine, canolamidopropyl betaine, cocamide betaine, cocamidoethyl betaine, cocamidopropyl betaine, cocamidopropyl hydroxysultaine, coco-betaine, coco-hydroxysultaine, Cocamidopropyl Hydroxysultaine, coconut alcohol, coco/oleamidopropyl betaine, Cocamidopropylamine Oxide, Cocamidopropylamine Oxide, decyl betaine, hydrogenated tallow betaine, Lauramide Oxide, Lauramidopropylamine Oxide, lauramidopropyl betaine, lauryl betaine, myristamidopropyl betaine, oleamidopropyl betaine, oleyl betaine, palm kernelamidopropyl betaine, palmamidopropyl betain, palmitamidopropyl betaine, sesamidopropyl betaine, soyamidopropyl betaine, stearyl betaine, tallowamidopropyl betaine, octylphenoxy polyethoxyethanol (triton x-100), tetradecyltrimethylammonium bromide (TTAB), Sodium lauryl sulfoacetate and/or sodium dodecyl sulphate, and/or acetamide MEA, apricotamide DEA, avocadamide DEA, avocadamide DIPA, babassuamide DEA, babassuamide MEA, Capramide DEA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA, Wheat germamide DEA, talloWamide DEA, talloWamide MEA, trideceth-2 Carboxamide MEA, undecylenamide DEA, undecylenamide MEA and/or Wheat germamide DEA.

### Fuels:

Where provided, the fuel may comprise any of the following. Where a fuel blend is provided, the fuel blend may comprise any two or more of the following:
A) Middle petroleum distillate fuels and/or fuel blends (Low viscosity), selected from on-road diesel (D), off-road diesel (Dₒ), marine gas oil (MGO)—DMX and/or DMA, marine diesel oil (MDO)—DMB and/or DMC) and heating oil.
B) Heavy and residues petroleum distillates fuels and/or fuel blends (high viscosity), selected from, heavy fuel oil (HFO), intermediate fuel oil (IFO), low sulphur fuel oil (LSFO), ultra-low sulphur fuel oil (ULSFO) and other fuels consisting mainly of residues from crude-oil distillation.
C) Light petroleum distillate fuels and/or fuel blends, selected from gasoline, kerosene and/or liquid naphtha.
D) Other hydrocarbon liquid fuels.
E) Renewable diesel (hydrocarbon biofuel) and/or fuel blends, such as, hydrotreated vegetable oil (HVO).
F) Alcohol-based fuels, selected from ethanol, methanol and/or any other alcohol fuel.
G) Biodiesel (non-hydrocarbon biofuel) and fuel blends, e.g. Fatty Acid Methyl Esters (FAME) and any other biodiesel.
H) Other renewable and non-hydrocarbon liquid fuels.
I) Liquid gaseous fuels, selected from butane, propane, and/or any other liquid gaseous fuel.

### Solvents:

One or more solvents may be independently selected from any one or more of the following groups:
i. pilot fuel, comprising hydrocarbon, biodiesel and/or alcohol-based fuels and/or fuel blends, selected from (A) to (D) above.
ii. liquid gas, selected from light naphtha, butane and/or any other gaseous fuel in liquid form between 10 at 50° C. and pressure between ambient to at least 40 Bar, of the total mass of the fuel blend; (I),
iii. Other solvents, comprising hydrocarbon, biodiesel and/or alcohols, for example, vegetable oils, methanol, ethanol, isopropyl alcohol (IPA), n-butanol, f-butane, trichloroethane, trichlorethylene, benzene, xylene and toluene.

### Additives for the Surfactant Formulation:

One or more additives may be independently selected from any one or more of the following groups:
i. Cetane improvers, for example, Octyl Nitrate (EHN or 2-Ethylhexyl nitrate), biodiesel and or vegetable oils.
ii. Corrosion inhibitors, for example, octyl 1H benzotriazole, ditertiary butylated 1H-Benzotriazole, propyl gallate, polyoxyalkylene polyols, octadecyl amines, nonyl phenol ethoxylates, calcium phenolates of hydrogenated pentadecyl phenol and magnesium alkyl benzene sulfonates;
iii. Anti-foaming, for example, silicone oil, polyvinyl alcohol and polyethers,
iv. Cold Flow Improvers, for example, ethylene-vinyl acetate copolymers, ethylene-vinyl acetate-hexene terpolymers, ethylene-vinyl acetate-diisobutylene terpolymers, ethylene/vinyl acetate/isobutyl vinyl ether terpolymers, (meth)acrylate, n-decyl (meth)acrylate, n-dodecyl (meth)acrylate, n-tetradecyl (meth)acrylate, n-hexadecyl (meth)acrylate and n-octadecyl (meth)acrylate;
v. Lubricity Improvers, for example, octyl phosphates and methyl hydroxy hydro cinnamide;
vi. Anti-wear agents, for example, zinc dithiophosphate and zinc dialkyl dithio phosphate tricresyl phosphate, glycerol mono oleate and stearic acid;
vii. Biodegradability Inhibitors, for example, phenol and anionic exopolysaccharides;
viii. Antioxidants (zinc compounds), for example, butylated hydroxytoluene, 2,4-dimethyl-6-tert-butylphenol, 2,6-di-tert-butylphenol, p-phenylenediamine and ethylenediamine;
ix. Detergents, dispersants and/or engine cleaners, for example, butylated hydroxytoluene, 2,4-dimethyl-6-tert-butylphenol, 2,6-di-tert-butylphenol, p-phenylenediamine, ethylene-vinyl ester copolymers, ethylenediamine, diethylhexyl adipate, polymethacrylate, polyvinylacrylate, calcium alkyl benzene sulfonate, sodium alkyl benzene sulfonate, propylene teramer succinimide of pentaethylene hexamine and octyl phosphonates;
x. Antiknock agents, Butylated hydroxytoluene, 2,4-Dimethyl-6-tert-butylphenol, 2,6-Di-tert-butylphenol, p-Phenylenediamine and Ethylenediamine;
xi. Smoke reducing agent, neem oil, mahua oil, ricebran oil, acetylated castor oil, linseed oil, karanja oil, ethyl hexyl ester of neem oil fatty acid, ethyl hexyl ester of karanj oil fatty acid, ethyl hexyl ester of neem oil fatty acid, toluene derivative of vegetable oil/its mono-esters;
xii. Other chemical compounds and/or materials, for example, renewable diesel, hydrogen peroxide, poly-glycols, polybutene's, dibasic acid esters, fluoropolymers, polyol esters, phosphate esters, silicones and/or poly-alpha olefins. alcohol oxygenates (methanol, ethanol, isopropyl alcohol, n-butane and f-butane) ether oxygenates (methyl tert-butyl ether, tertiary amyl methyl ether, tertiary hexyl methyl ether, ethyl tertiary butyl ether, tertiary amyl ethyl ether, diisopropyl ether, other fuel improvers and marker dyes.

### Other Chemical Compounds for the Formulation:

Some chemical compounds may be provided to help reduce the sulphur amount of the fuel(s) and/or micro- or nanoemulsion. Preferably this is done where oil is the continuous phase, at temperatures between 10° C. to 50° C., at ambient pressure to 8 Bar, specially of those containing fuels and/or blends of medium to high sulphur content (<100 ppm).

For example, nanoparticle ceramics filters may be provided or used, comprising materials independently selected from a group comprising: activated carbon, alumina, metal oxides, zeolite, and any other porous ceramic-based adsorbent.

In another example, rare-earth magnets (lanthanide) may be provided or used, and may be independently selected from neodymium type magnets (such as grades N35 to N52), and/or samarium-cobalt type magnets. The magnets may for example be fitted to the external housing of a low energy mixing and/or emulsification device

What is claimed is:

1. A process for producing a microemulsion or nanoemulsion comprising water and at least one hydrocarbon or oil, comprising the steps of:
a) providing the hydrocarbon or oil, water, one or more additives, a solvent, and a hydrophilic surfactant formulation comprising an amine or amide derivative non-ionic surfactant which is a fatty acid alkanolamide, one or more ethoxylated alcohols and/or ethoxylated alkylphenols, and a non-ionic fatty acid ester;
b) by a mixing or stirring device operating at a mixing or stirring speed in the range of 100 rpm and 15000 rpm, mixing or stirring the hydrophilic surfactant formulation and additive into the solvent, to produce a hydrophilic self-emulsifying blend;
c) adding water to the hydrophilic self-emulsifying blend and the hydrocarbon or oil to produce a water-in-hydrocarbon/oil microemulsion or nanoemulsion, wherein the microemulsion or nanoemulsion comprises:
46% or more by mass of the hydrocarbon or oil,
4% to 36% by mass of water,
a mass ratio of hydrophilic surfactant formulation to water in the range 1:10 to 1:2,
0.1% to 5% by mass of additive,
1.2% or more by mass of the solvent,
a dispersed particle size in the range 1 nm to 500 nm, and
a polydispersity index of 35% PdI or less,
wherein the percentages by mass of the hydrocarbon or oil, water, formulation, additive and solvent together add up to 100%.

2. The process of claim 1, in which a second lipophilic emulsifying blend is provided, for correcting the microemulsion and nanoemulsion properties, the second lipophilic emulsifying blend including a second solvent and a second lipophilic surfactant formulation, in which the second lipophilic surfactant formulation to second solvent mass ratio is in the range 1:1 to 1:5 having an HLB value less than 9, comprising:
1% to 20% by mass of one or more non-ionic lauric fatty acid-based alkanolamide, independently selected from a group comprising: cocamide DEA, lauramide DEA, palm kernelamide DEA;
50% to 100% by mass of at least one or more non-ionic fatty acid ester which is a sorbitan alkyl ester independently selected from the group comprising: sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85);
1% to 10% by mass of one or more non-ionic fatty acid ester which is a polyoxyethlyene derivative of a sorbitan alkyl ester independently selected from the group comprising: polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85);
1% to 40% by mass of one or more, ethoxylated alcohols and/or alkyl phenols non-ionic co-co-surfactants, independently selected from the group comprising: nonylphenol ethoxylate and alcohol ethoxylate.

3. The process of claim 1, in which the fatty acid alkanolamide includes lauramide DEA, palm kernelamide DEA or cocamide DEA.

4. (canceled)

4. The process of claim 1, in which a emulsifying blend of hydrophilic surfactant formulation is provided, the emulsifying blend including a solvent and a hydrophilic surfactant formulation, in which the surfactant formulation to solvent mass ratio is in the range 1:1 to 1:5, the hydrophilic surfactant having a HLB value higher than 9 and less than 15, comprising:
50% to 100% by mass of one or more non-ionic lauric fatty acid-based alkanolamide, independently selected from a group comprising: cocamide DEA, lauramide DEA, palm kernelamide DEA;
1% to 30% by mass of at least one or more non-ionic fatty acid ester which is a sorbitan alkyl ester independently selected from the group comprising: sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85);
30% to 70% by mass of one or more non-ionic fatty acid ester which is a polyoxyethlyene derivative of a sorbitan alkyl ester independently selected from the group comprising: polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85).

5. An apparatus for implementing the process of claim 1 in a hydrocarbon flow or oil flow, the apparatus comprising
a hydrocarbon or oil tank,
a feed line connected to the tank for conveying the hydrocarbon or oil,
a pump for pumping hydrocarbon or oil from the tank along the feed line,
a mixing device arranged in the feed line, the mixing device comprising an inlet, an outlet, at least one mixing or emulsifying chamber disposed between the inlet and the outlet, a turbulator or turbulator nozzle at an inlet side of the chamber for in use creating a non-laminar flow within the chamber for generating turbulence in the flow, and a plurality of spheres or obstructions at an outlet side of the chamber for in use enhancing the turbulence in the flow and generating a high turbulence region;
a reservoir for a hydrophilic emulsifying blend, and a water reservoir, which are both connected to the feed line or the at least one mixing chamber for introducing water and the hydrophilic emulsifying blend, which includes a hydrophilic surfactant formulation, additive and solvent, into the flow during use for reducing emissions.

6. An apparatus for implementing the process of claim 1, in which mixing means is provided for mixing the hydrophilic emulsifying blend and water with the hydrocarbon or oil to form the microemulsion or nanoemulsion in a second mixing chamber, and a conduit for in use conveying the microemulsion or nanoemulsion from the second mixing chamber to the feed line or first mixing chamber.

7. An apparatus for implementing the process of claim 1, in which at least two nozzles are connected to the hydrophilic emulsifying blend reservoir and the water tank for dosing hydrophilic emulsifying blend and water into the feed line or mixing chamber for in use forming a water-in-hydrocarbon or water-in-oil microemulsion or nanoemulsion.

8. An apparatus for implementing the process of claim 1, comprising at least one additional hydrocarbon or oil tank, and blending means configured to receive hydrocarbon or oil from the tanks and blend them together for feeding into the mixing chamber.

9. An apparatus for implementing the process of claim 1, connected to a fuel system for an engine, generator, turbine, burner or other combustion device for enhancing fuel combustion efficiency.

10. An emulsifying blend of hydrophilic surfactant formulation for mixing with water and hydrocarbon to form a microemulsion or nanoemulsion of water-in-hydrocarbon, the hydrophilic surfactant formulation in the emulsifying blend having a HLB value greater than 9 and less than 15, the hydrophilic surfactant formulation comprising:
50% to 99% by mass of one or more non-ionic lauric fatty acid-based diethanolamides independently selected from a group comprising: cocamide DEA, lauramide DEA and palm kernelamide DEA;
25% to 50% by mass of one or more non-ionic fatty acid based alkanolamides, independently selected from the group (a) below:
a) acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA;
one or both of:
i) 1% to 30% by mass of at least one non-ionic fatty acid ester which is a sorbitan alkyl ester;
ii) 1% to 30% by mass of at least one non-ionic fatty acid ester which is a polyoxyethlyene derivative of a sorbitan alkyl ester;
1% to 70% by mass of one or more ethoxylated alcohols, ethoxylated alkylphenols and/or ethoxylated thiols; and
0.1% to 20% by mass of one or more further surfactants which are non-ionic, anionic, cationic or zwitterionic.

11. An emulsifying blend of surfactant formulation according to claim 10, in which the sorbitan alkyl ester is independently selected from a group comprising: sorbitan monolaurate (Span 20), sorbitan monopalmitate (Span 40), sorbitan monostearate (Span 60), sorbitan tristearate (Span 65), Sorbitan monooleate (Span 80), sorbitan etrioleate (Span 85).

12. An emulsifying blend of surfactant formulation according to claim 10, in which the polyoxyethlyene derivative of the sorbitan alkyl ester is independently selected from a group comprising: polyoxyethylene sorbitan monolaurate (Tween 20), polyoxyethylene sorbitan monopalmitate (Tween 40), polyoxyethylene sorbitan monostearate (Tween 60), polyoxyethylene sorbitan triestearate (Tween 65), polyoxyethylene sorbitan monooeleate (Tween 80), polyoxyethylene sorbitan trioeleate (Tween 85).

13. An emulsifying blend of surfactant formulation according to claim 10, in which the sorbitan alkyl ester is sorbitan monooleate, and/or in which the polyoxyethlyene derivative of the sorbitan alkyl ester is polyoxyethylene sorbitan monooeleate.

14. An emulsifying blend of surfactant formulation according to claim 10, in which the ethoxylated alcohol is alcohol ethoxylate and/or the ethoxylated alkylphenol is nonylphenol ethoxylate.

15. An emulsifying blend of surfactant formulation according to claim 10, in which the surfactant formulations are independently selected from the group (a) and/or independently selected from a second group comprising:
b) almondamidopropyl betaine, Alkyl polyethylene glycol ether, apricotamidopropyl betaine, capryl/capramidopropyl betaine, canolamidopropyl betaine, cetearyl Alcohol, cetrimonium bromide, cocamide betaine, cocamidoethyl betaine, cocamidopropyl betaine, cocamidopropyl hydroxysultaine, coco-betaine, coco-hydroxysultaine, coconut alcohol, coco/oleamidopropyl betaine, Cocamidopropylamine Oxide, decyl betaine, glyceryl stearate SE, Glyceryl Caprylate/Caprate, hydrogenated tallow betaine, Lauramide Oxide, Lauramidopropylamine Oxide, lauramidopropyl betaine, lauryl betaine, Lauryl/Myristyl Amidopropyl Amine Oxide, lauryl alcohol ethoxylates, myristamidopropyl betaine, oleamidopropyl betaine, oleyl betaine, palm kernelamidopropyl betaine, palm amidopropyl betain, palmitamidopropyl betaine, propylene glycol stearate, sesamidopropyl betaine, soyamidopropyl betaine, stearyl betaine, tallowamidopropyl betaine, trilaneth-4 phopshate, octylphenoxy polyethoxyethanol (triton x-100), tetradecyltrimethylammonium bromide (TTAB), Sodium lauryl sulfoacetate, Sodium cetearyl sulfate, and sodium dodecyl sulphate.

16. A microemulsion or nanoemulsion comprising:
46% or more by mass of hydrocarbon or oil as a continuous phase of the microemulsion or nanoemulsion,
4% to 36% by mass of liquid or gaseous water,
a emulsifying blend of hydrophilic surfactant formulation, for mixing with water and hydrocarbon to form a microemulsion or nanoemulsion of water-in-hydrocarbon, the hydrophilic formulation to solvent mass ratio is in the range 1:3 to 1:5, having a HLB value greater than 9 and less than 15, comprising:
50% to 99% by mass of one or more non-ionic lauric fatty acid-based diethanolamides independently selected from a group comprising: cocamide DEA, lauramide DEA and palm kernelamide DEA;
25% to 50% by mass of one or more non-ionic fatty acid based alkanolamides, independently selected from the group comprising: acetamide MEA, almondamide DEA, apricotamide DEA, avocadamide DEA, avocadamide DIPA, babassuamide DEA, babassuamide MEA, Capramide DEA, cocamide DEA, cocamide DIPA, cocamide MEA, cocamide MIPA, cocoyl sarcosinamide DEA, comamide/cocamide DEA, cornamide DEA, diethanolaminooleamide DEA, disodium cocamido MIPA PEG-4 sulfosuccinate, disodium lauramido MIPA, glycol sulfosuccinate, hydrogenated tallowamide DEA, hydroxyethyl ethylene dipalmitamide, hydroxyethyl stearamide-MIPA, hydroxypropyl bisisostearamide MEA, hydroxypropyl bislauramide MEA, hydroxypropyl bispalmitamide MEA, hydroxystearamide MEA, isostearamide DEA, isostearamide MEA, isostearamide MIPA, lactamide MEA, lanolinamide DEA, lauramide DEA, lauramide MEA, lauramide MIPA, lauramide/Myristamide DEA, lauryl Malamide, lecithinamide DEA, linoleamide DEA, linoleamide MEA, linoleamide MIPA, minkamide DEA, myristamide DEA, myristamide MEA, myristamide MIPA, oatamide MEA, oleamide DEA, oleamide DIPA, oleamide MEA, oleamide MIPA, olivamide DEA, oliveamide MEA, palmamide DEA, palmamide MEA, palmamide MIPA, palmitamide DEA, palmitamide MEA, palm kernelamide DEA, palm kemelamide MEA, palm kernelamide MIPA, pantothenamide MEA, nutamide MEA, peanutamide MIPA, PEG-20 pocamide MEA, ricebranamide DEA, ricinoleamide DEA, ricinoleamide MEA, ricinoleamide MIPA, sesamide DEA, sesamide DIPA, soyamide DEA, stearamide AMP, stearamide DEA, stearamide DEA-distearate, stearamide DIBA-stearate, stearamide MEA, stearamide MEAstearate, stearamide MIPA, tallamide DEA, talloWamide DEA, talloWamide MEA, trideceth-2 Carboxamide MEA, undecylenamide DEA, undecylenamide MEA and/or Wheat germamide DEA;
one or both of:
i) 1% to 30% by mass of at least one non-ionic fatty acid ester which is a sorbitan alkyl ester;
ii) 1% to 30% by mass of at least one non-ionic fatty acid ester which is a polyoxyethlyene derivative of a sorbitan alkyl ester;
1% to 70% by mass of one or more ethoxylated alcohols, ethoxylated alkylphenols and/or ethoxylated thiols; and
0.1% to 20% by mass of one or more further surfactants which are non-ionic, anionic, cationic or zwitterionic;
in which the hydrophilic surfactant formulation to water mass ratio is in the range 1:5 to 1:2.5,
0.1% to 5% by mass of additive, and
1.2% or more by mass of solvent,
in which the microemulsion or nanoemulsion has a dispersed particle size in the range 1 nm to 200 nm, and a polydispersity index of 30% PdI or less,
wherein the percentages by mass of the hydrocarbon or oil, water, formulation, additive and solvent together add up to 100%.

17. (canceled)

18. (canceled)
